(19) United States
(12) Patent Application Publication
(10) Pub. No.: US 2014/0379304 A1
(43) Pub. Date: Dec. 25, 2014

(54) EXTRACTING TIMING AND STRENGTH OF EACH OF A PLURALITY OF SIGNALS COMPRISING AN OVERALL BLAST, IMPULSE OR OTHER ENERGY BURST

(71) Applicant: Douglas A. Anderson, West Chester, PA (US)

(72) Inventor: Douglas A. Anderson, West Chester, PA (US)

(21) Appl. No.: 14/308,827

(22) Filed: Jun. 19, 2014

Related U.S. Application Data
(60) Provisional application No. 61/836,783, filed on Jun. 19, 2013.

(51) Int. Cl. G01N 29/46

(52) U.S. Cl. CPC G01N 29/46
USPC 702/190

(57) ABSTRACT

A method for extracting data from an overall signal, generated by a plurality of impulses, by use of a computer using wavelet transform analysis of timing and strength of each of said plurality of impulses is disclosed. The method includes using a Discrete Wavelet Transform analysis or a Continuous Wavelet Transform analysis.

### CROSS-REFERENCE TO RELATED APPLICATION

The present application claims priority from U.S. Provisional Patent Application Ser. No. 61/836,783, filed on Jun. 19, 2014, which is incorporated herein by reference in its entirety.

### FIELD OF THE INVENTION

The present invention enables signal analysis and acquisition of information relating to a plurality of vibration sources (such as detonations taking place in individual blast holes separated in time and space) which result in an overall signal or overall impulse generated by the individual detonations. More particularly, in accordance with the present invention such information may be derived from a signal monitoring station at a location remote from the actual site of the blast or impulses.

At least one embodiment of the invention may be used to characterize performance of explosives during a blast by analyzing the vibration generated by the blast. By use of the present invention it is possible to use the information to assess how the explosive energy is used. Prior to the present invention, such an assessment has not been possible using this type of data.

### BACKGROUND OF THE INVENTION

There is a need to acquire information with respect to individual blasts or events of vibration which make up an overall blast or impulse wave form by monitoring this event at a remote location in the form of an overall impulse, signal or wave form.

The field of blasting, for example has come under significant regulation because of the nature of what is being done and the risk to other property, people and life.

The methods in use today to monitor such blasting are not satisfactory, and at best are done by Fourier transforms which only reveal the frequency content of the overall blast signal or wave form. In this manner, the only truly useful information that is acquired is the maximum amplitudes of the dominant frequencies. When this type of information is used to monitor blasting, very conservative blasting must be performed where the most efficient use of the explosive energy cannot be achieved, whether it be in mining, quarrying, excavation for construction or other activities requiring blasting. This process, however, is based on expensive and labor-intensive methods.

### SUMMARY OF THE INVENTION

The present invention provides advantages in that an overall signal or wave form comprising a plurality of signals or wave forms may be analyzed from a single location remote from the actual plurality of impulse sources enabling determination of the separation in time and strength of individual impulses making up the overall signal.

One aspect of the present invention is that it enables analysis of each of the separate vibratory, acoustic, or explosive detonation sources that generate the overall signal or wave form. In this manner, individual vibration, acoustic, or explosive detonation sources making up an overall signal or wave form may be analyzed to provide useful information both as to timing and strength of each of a plurality of such impulses, for example a detonation in a blast hole, and the timing of each detonation.

In accordance with the present invention, a method and apparatus is disclosed which comprises extracting from an overall signal or waveform, generated by a plurality of impulses, by use of a computer using wavelet transform analysis of the timing and strength of each of the plurality of signals, waveforms or impulses making up the overall signal.

In one particular application, the present invention is particularly useful as a method and apparatus for monitoring an overall blast wave form produced by a blasting operation wherein multiple blast holes are fired in sequence with delays between each of the firings. In accordance with the method of the present invention, information may be extracted from the overall wave form or signal, generated by the plurality of component detonations in each of the blast holes, by use of a computer using wavelet transform analysis of timing and strength of each of the plurality of detonation impulses.

### BRIEF DESCRIPTION OF THE DRAWINGS

The accompanying drawings, which are incorporated herein and constitute part of this specification, illustrate exemplary embodiments of the invention, and, together with the general description given above and the detailed description given below, serve to explain the features of the invention. It is understood, however, that this invention is not limited to the precise arrangements and instrumentalities shown. In the drawings:

FIG. 1 is a wavelet transform scalogram that may be used to assess qualitative analysis to determine if all of the holes detonated from low-scale amplitudes.

FIG. 2 is a top plan view of the scalogram shown in FIG. 1.

FIG. 3 is a Wavelet Transform Maximum Modulus (WTMM) calculated from FIG. 2 to determine peaks and peak traces.

FIG. 4 is a typical blast vibration wave form from which timing and strengths of individual blasts may be extracted using the present invention.

FIG. 5 is a scalogram that may be produced using the present invention.

FIG. 6 is a scalogram that may be produced in accordance with the present invention.

FIG. 7 is a Wavelet Transform Maximum Modulus which may be produced utilizing the present invention.

FIG. 8 is a plot of a trace which indicates the slope of the Wavelet Transform Maximum Modulus in a particular example.

FIG. 9 is a plot showing a Holder exponent derived from a Wavelet Transform Maximum Modulus (WTMM).

FIG. 10A is a seismographic record of a transverse component of a blast vibration wave form utilized in illustrating the present invention.

FIG. 10B is a seismographic record of a vertical component of the blast vibration wave form of the blast shown in FIG. 10A.

FIG. 10C is a seismographic record of a longitudinal component of the blast vibration wave form of the blast shown in FIG. 10A.

FIG. 11A is a graph showing a Continuous Wavelet Transform scalogram produced utilizing the present invention for the transverse component of the blast vibration wave from shown in FIG. 10A.

FIG. 11B is a graph showing a Continuous Wavelet Transform scalogram produced utilizing the present invention for the vertical component of the blast vibration wave from shown in FIG. 10B.

FIG. 11C is a graph showing a Continuous Wavelet Transform scalogram produced utilizing the present invention for the longitudinal component of the blast vibration wave from shown in FIG. 10C.

FIG. 12A is an overhead view showing the Continuous Wavelet Transform scalogram produced utilizing the present invention for the transverse component of the blast vibration wave from shown in FIG. 10A.

FIG. 12B is an overhead view showing the Continuous Wavelet Transform scalogram produced utilizing the present invention for the vertical component of the blast vibration wave from shown in FIG. 10B.

FIG. 12C is an overhead view showing the Continuous Wavelet Transform scalogram produced utilizing the present invention for the longitudinal component of the blast vibration wave from shown in FIG. 10C.

FIG. 13A is a WTMM produced from the transverse component of the blast vibration wave shown in FIG. 10A.

FIG. 13B is a WTMM produced from the vertical component of the blast vibration wave shown in FIG. 10B.

FIG. 13C is a WTMM produced from the longitudinal component of the blast vibration wave shown in FIG. 10C.

FIG. 14A is a close-up of WTMM showing low-scale firing pulses from the transverse component of the blast vibration wave shown in FIG. 10A.

FIG. 14B is a close-up of WTMM showing low-scale firing pulses from the vertical component of the blast vibration wave shown in FIG. 10A.

FIG. 14C is a close-up of WTMM showing low-scale firing pulses from the longitudinal component of the blast vibration wave shown in FIG. 10A.

FIG. 15 is a graph of an exemplary Fourier Transform measuring a blast wave.

FIG. 16 is a graph showing analysis of different sizes of windows for performing windowed Fourier transform analysis.

FIG. 17 is a mother wavelet which may be used in accordance with the present invention showing the real and imaginary parts.

FIG. 18 is a flow diagram showing an exemplary procedure used to form a wavelet transform from a mother wavelet according to the present invention.

FIGS. 19A, 19B, and 19C are flow diagrams of the presently preferred embodiment of a method of practicing the present invention using CWT.

FIG. 20 is a flow chart of an alternate embodiment of the method of the present invention utilizing discrete wavelet transforms.

FIG. 21 is a schematic drawing showing the exemplary arrangement of two recorders used to record blast data from a plurality of blasts.

### DETAILED DESCRIPTION OF EXEMPLARY EMBODIMENTS

In the drawings, like numerals indicate like elements throughout. Certain terminology is used herein for convenience only and is not to be taken as a limitation on the present invention. The terminology includes the words specifically mentioned, derivatives thereof and words of similar import. The embodiments illustrated below are not intended to be exhaustive or to limit the invention to the precise form disclosed. These embodiments are chosen and described to best explain the principle of the invention and its application and practical use and to enable others skilled in the art to best utilize the invention.

Explosive detonation in a borehole in rock generates stress waves due to the rapidly expanding gases. These waves comprise both compression waves (p-waves) and shear waves (s-waves). In p-waves, the particle motion is in the direction of the wave motion; in s-waves, the particle motion is perpendicular to the direction of the wave motion. The p-waves travel faster than the s-waves. The waves interact with discontinuities in the rock as they pass through the rock. These discontinuities may be existing joints, fractures, or bedding planes, or fractures newly created by explosive detonations in the same detonation sequence. The interaction with the discontinuities will create new fractures and extend old ones.

At some point, the strength of the stress waves will decrease below the level needed to create or extend fractures; at this point the stress waves will propagate as elastic waves, or “vibration”. The decrease is partially due to geometric spreading, and partially due to the fact that the stress waves lose strength by fracturing rock. The vibration may be in the form of the stress waves, or other waves, including, but not limited to, sound waves. Such vibrations and the measurements of those vibrations can be used to determine characteristics of explosive detonation blasts, gunshots, structural failure, or other events.

It has been shown that the fracturing process generates new waves, known as “acoustic emission waves”, during static fracturing experiments. These acoustic emission waves may differ from the original stress waves.

The elastic “vibration” waves will be reflected and refracted at other discontinuities as the vibration propagates away from the source area. These reflected and refracted waves will have lower frequency content than the original waves.

Furthermore, in a production blast there are typically many boreholes with explosives that are detonated within a short period of time. The waves generated and propagated by each of these boreholes will often overlap, making the resultant vibration more complicated.

There is therefore then a very complex suite of waves that can be recorded at a distance from a blast, comprising:

(a) the originally generated waves;

(b) the reflected and refracted waves; and

(c) waves due to acoustic emission, created by the fracturing process.

These waves in some way are diagnostic of the explosive process in fragmenting rock because, when the explosive originally detonates, due to explosive performance, coupling with the rock, and efficiency of the fragmentation process, not all of the explosive energy is used in fracturing the rock. The proportion of energy that is “wasted” (or not used in fracturing rock) is the “seismic efficiency”.

When explosives are used to fracture rock (as in mining, construction, or quarrying), it is desirable for the seismic efficiency to be as low as possible. Conversely, when explosives are used to determine geologic structure in geophysical prospecting, it is desirable for the seismic efficiency to be as high as possible.

The present invention is a diagnostic tool that can be used to extract the explosive performance from the waves generated by a blast. A crucialelement of the invention is the ability to separate the original waves generated from all of the other waves that follow.

A seismological principle that is important is that the reflected and refracted waves have lower frequency content than the original wave. Therefore high frequency waves, discontinuities, or singularities in the wavetrain are evidence of the original detonation.

The present invention uses a technique to analyze the high-frequency part of the waves as a function of time. The present invention seeks to quantitatively associate a given amplitude or characteristic of these waves with the explosive performance. Such characteristics can be the strength of each detonation, the breadth (or length of time) of each detonation, and the impulsiveness (broad v. sharp rise) of each detonation.

This needs to be quantified empirically by correlating both the in-hole explosive performance and the resultant fragmentation. Analysis of the vibration would eventually be simpler than measuring the in-hole explosive performance.

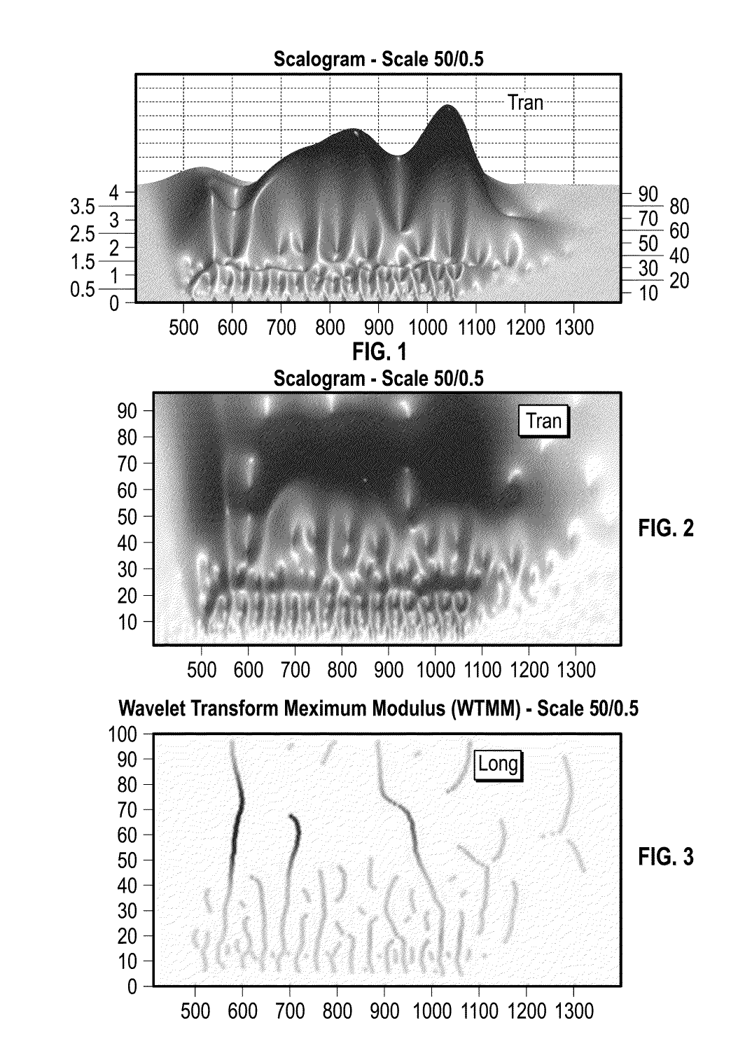

The present invention is a wavelet-based method for analysis of blast-generated vibrations to determine explosive product performance which in general includes the steps of:
(a) acquiring one or more components of seismic trace generated by a blast caused by detonating an explosive;
(b) applying a Continuous Wavelet transform to at least one seismic trace, said wavelet transform having a basis wavelet and producing wavelet coefficients for localized scales and localized time points;
(c) displaying a scalogram as shown in FIGS. 1 and 2 to assess qualitative analysis to determine if all holes detonated from low-scale amplitudes;
(d) calculating a Wavelet Transform Maximum Modulus (WTMM) as shown in FIG. 3 to determine peaks, and peak traces; and
(e) determining a Hölder Exponent by evaluating amplitude of the WTMM Peak as a function of scale, i.e., at constant time.

Vibration is essentially an unavoidable waste product of a blast, representing the explosive energy that has not been effectively utilized in fracturing the rock and displacing the fractured pieces.

Virtually all blasts use a plurality of explosive charges detonated in separately drilled boreholes. These explosive charges are set off in a predetermined time sequence of short duration. The time interval between individual charges typically ranges from about 8 milliseconds to about 100 milliseconds, where a millisecond is one-thousandth of a second.

Not all of the explosive energy in a blast is productive. Since over six billion pounds of explosives are used every year in the United States and Canada alone, the economic impact of even small changes in explosive efficiency can be huge. It is therefore important to be able to assess this efficiency in an economically practical manner, as a function of changes in blast design (explosive type, delay sequence, borehole configuration).

There are currently two methods of assessing such efficiency. One requires putting instrumentation (which is destroyed by the explosion) into the borehole. This indicates how the explosive detonates, but not how the explosive fractures the rock. The other way looks at the performance of the blasted rock at a rock crusher. These methods give an overall assessment of the fragmentation, but do not indicate how individual charges performed.

As discussed above, blast vibration is related to the explosive efficiency; at a given distance, and for a given charge weight of explosive, higher vibration generated at the source is indicative of a less effective conversion of that energy into fracturing and displacement of the rock.

The vibration waves that are measured as common practice appears rather complicated, because as a vibration wave propagates through the medium (rock) from the blast source to a receiver, the ubiquitous discontinuities such as bedding planes, joints, and fractures create reflections and refractions of the incoming waves. Furthermore, different kinds of waves are generated by the explosive, such as compressional waves (p-waves) and shear waves (s-waves). Each interaction of a wave with a discontinuity generates new both p- and s-waves.

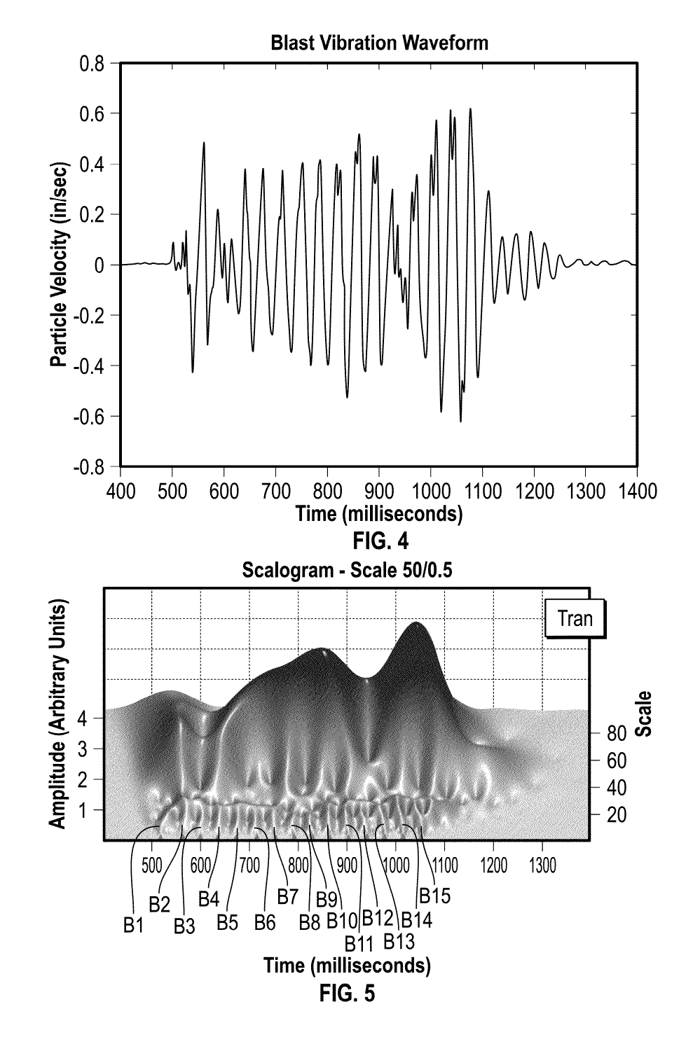

An example of a blast vibration waveform is shown in FIG. 4. This is one component of a seismogram recorded about 300 feet from a blast. The blast had fifteen explosive-loaded holes in a single row, detonated with separate time delays, and with equal charge weights. It is important to note that the number and the timing of the blasts cannot be determined from the waveform of FIG. 4. It is only after using wavelet transforms in accordance with the present invention that one can determine the number and timing of each individual blast, as is identified in FIG. 5 as B1-B15.

Until this application of wavelet transforms to blast seismograms, it was thought that determination of the firing times and explosive performance could not be determined from the blast vibration. Because of two important elements, this can now be done. Information about the original signal generated by the explosive remains in the waveform as a high frequency relic as the wave is propagated. This is because all of the reflections and refractions have lower frequencies than the original signal.

The wavelet transform, unlike the commonly used Fourier transform, shows both time and frequency on the same plot. In the wavelet transform, the frequency representation is termed “scale”, which is inversely proportional to the frequency. Therefore, the frequency characteristics can be seen as a function of time. Since the representation of the original explosive energy is in the high frequency relic described above, this information can be extracted from the complicated waveform.

The underlying principle is that a signal (wave) can be decomposed into constituents in a manner similar to the way Fourier analysis decomposes a signal, but with significant differences. In Fourier analysis, the sines and cosines comprise a set of basis functions.

For wavelet transforms, these basis functions are wavelets, which are a compressed and finite-length wave that is dilated (expanded) and translated in the analysis process. The initial form of the wavelet is often termed the “mother wavelet.”

A wavelet that is used in the Continuous Wavelet Transform (CWT) analysis in this invention, is called the complex Morlet wavelet. This wavelet, Ψ(t), is defined as

Ψ(t)=e^{(-σ}^{²}^{t}^{²}^{-2πif}^{₀}^{t)} (1)

which is basically a sinusoidal function of time t with a Gaussian envelope. The −σ²t² portion of the exponent corresponds to the Gaussian envelope with σ related to the width of the envelope. The −2πif₀t portion corresponds to a sine wave with an initial (undilated) frequency f₀.

All wavelets must satisfy admissibility criteria, such that they are of finite energy:

$${\int }_{- ∞}^{∞} \frac{{\vert ψ ( ω ) \vert}^{2}}{\vert ω \vert} d ω < ∞ \qquad ( 2 )$$

The wavelet transform W is a function of scale a (˜1/frequency) and translation b. The equation for the wavelet transform is a convolution of the wavelet Ψ(t) with the signal f(t):

$$W ( a , b ) = {\int }_{- ∞}^{∞} \frac{f ( t ) 1}{\vert a \vert} ψ \cdot ( \frac{t - b}{a} ) d t \qquad ( 3 )$$

Ψ* represents the complex conjugate of the mother wavelet. For each a and b pair (that is at each point b in the waveform and each scale a), the integral is calculated over the entire data sample.

There are two types of wavelet transform that are defined by the way the scale a is stepped, namely:

(1) the Continuous Wavelet Transform (CWT), and

(2) the Discrete Wavelet Transform (DWT).

The DWT limits the scales to powers of 2. The wavelet itself is discretized over positive integers j and k as follows:

$${ψ}_{j , k} ( t ) = {2}^{\frac{j}{2}} ψ ( {2}^{j} t - k ) \qquad ( 4 )$$

Dyadic scales are used such that the scales and positions are powers of 2: a=2^{j} and b=k2^{j}. The results for the decompositions are plotted as waveforms in the time domain. Typically all of the decompositions are shown on a single diagram known as a multiresolution analysis.

In contrast, the CWT does not limit the stepping of scale to powers of 2, but allows arbitrary equal step levels; there is therefore redundancy in the calculations. The CWT is the most appropriate wavelet analysis technique to be used initially for this invention, because the appropriate scale may not be known a priori. Therefore, scale choice is part of the protocol for the invention, as discussed below.

The scalograms are representations of the modulus of the wavelet transform |W(a,b)| in a and b space. The scalogram can be represented with a variety of display techniques, but the most effective is to have a display that is similar to a relief drawing. A scalogram of the waveform shown in FIG. 4 is shown below in FIG. 5 with the relief view.

Although it would not be possible to ascertain when the individual explosive charges fired from the waveform shown in FIG. 4, the ridges at the highest scale (i.e., the foreground) in the scalogram in FIG. 5 clearly show evidence of vibration from each of the explosive charges.

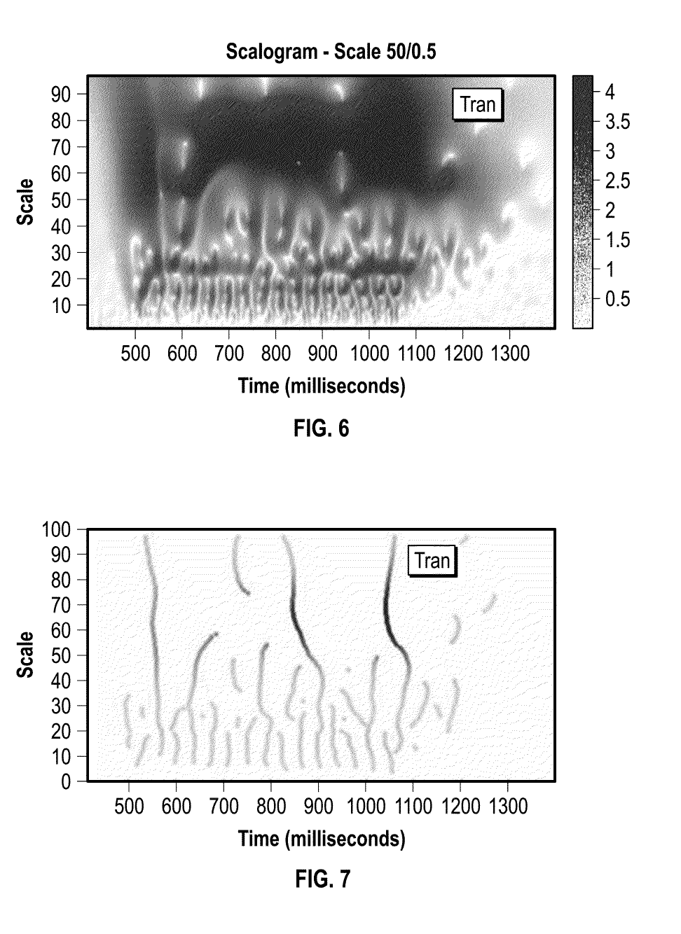

The view on FIG. 5 is from an angle of 60° above horizontal; FIG. 6 below shows the same scalogram from an angle of 90° above horizontal, i.e., directly above. The amplitude of the modulus is shown by the darkness, as represented by the colormap on the right of FIG. 6.

Once again, FIG. 6 shows the ridges at low scale (between 10 and 20) that correspond to signals representing explosive detonations. The higher amplitude peaks at higher scale are representative of the geological structure between the blast and the seismograph. This invention is primarily interested in the properties associated with detonations that are evidenced in the low-scale wavelet transform moduli.

A further computational processing of the data represented in FIGS. 5 and 6 can determine the strength of the vibration generated by the explosive. The location and amplitude of the crest of the ridges can be assessed by determination of the maximum values in a traverse at constant scale across the time axis. This is called Wavelet Transform Maximum Modulus calculation, or WTMM. FIG. 7 is the WTMM for the event shown in FIGS. 5 and 6. Amplitude of the WTMM corresponds to the darkness of the data points—the darker the data points, the higher the amplitude.

The WTMM values obtained can, in turn, be used to calculate what is known as the Hölder or Lipschitz exponent (α), which shows the decay of the WTMM (|W|) vs. scale (a) at constant translation (b):

$$α = \frac{log \vert W \vert}{log ( a )} \qquad ( 5 )$$

This exponent has been shown to be a measure of the impulsiveness of a signal in various theoretical as well as empirical studies.

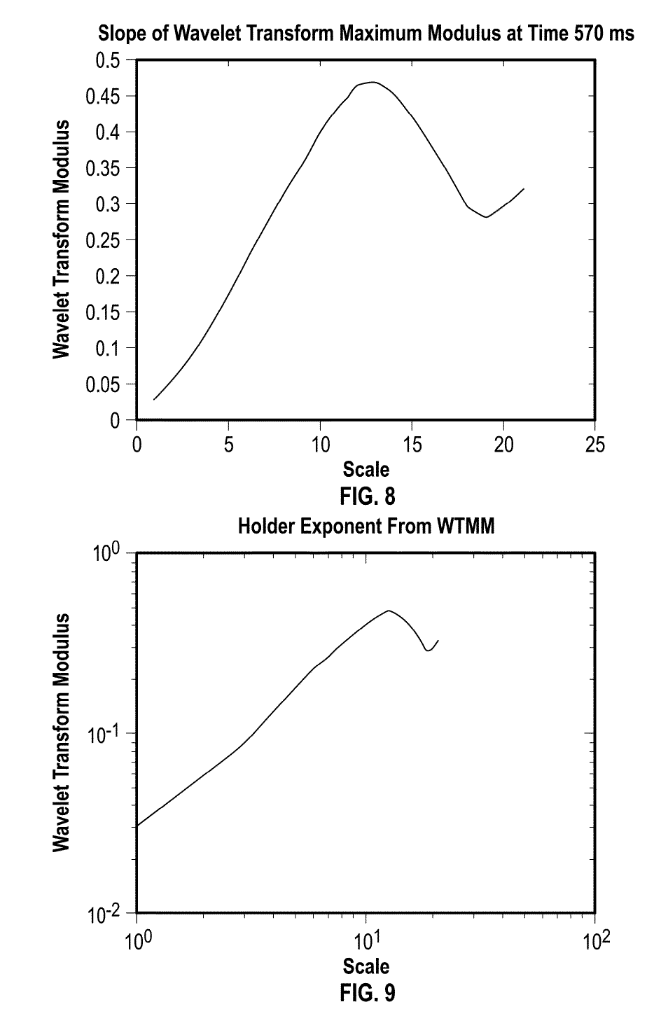

FIG. 8 is a plot of the trace shown in FIG. 7 at 600 milliseconds, with the ordinate axis representing the amplitude or modulus, and the abscissa the scale. Data over the scale interval from 1 to 22 is plotted, because this represents the scale range corresponding to the ridges seen in the scalograms and the WTMM plots associated with the impulses (i.e., the blast detonations).

As can be seen in Equation 5, the actual value of the Holder/Lipschitz exponent α is calculated from the logarithm of both W and a. This is shown in FIG. 9. The image in FIG. 8 allows one to easier see the relation of the scale to that in the WTMM plots. This exponent empirically describes the character of discontinuities in a function.

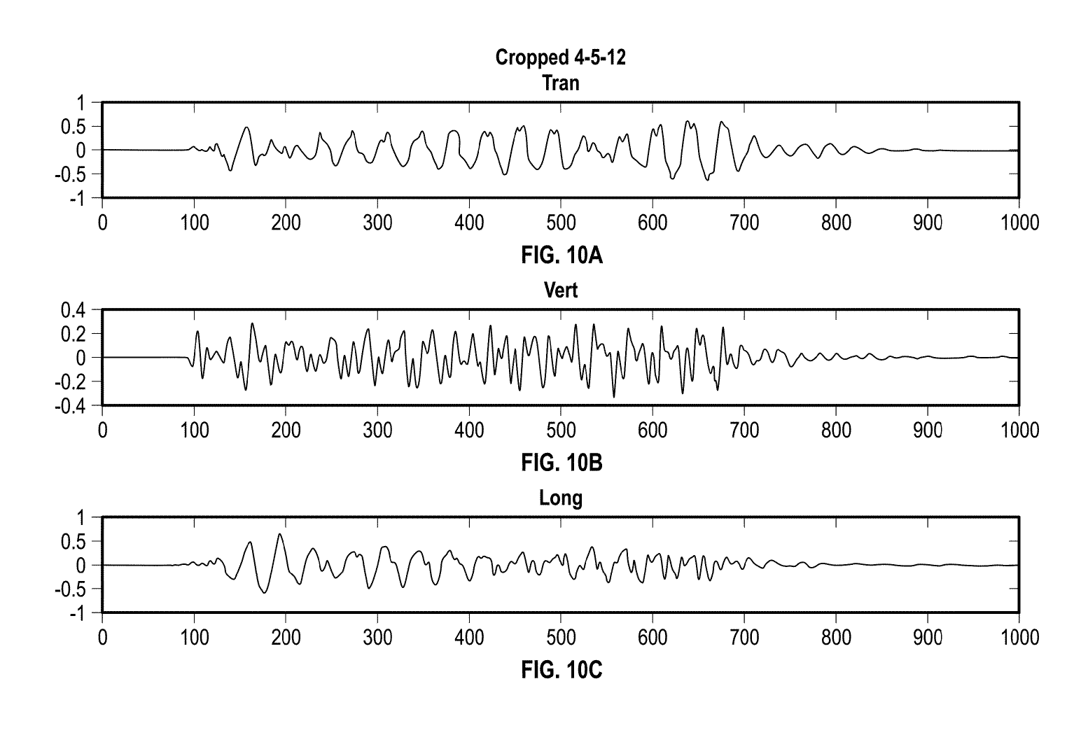

Referring now to an exemplary embodiment of the invention in the field of blast performance analysis, see FIGS. 10A-14C.

Blast vibration seismograms are generally collected strictly for compliance with regulations. The peak levels (including dominant frequency) are typically all that are looked at. However, these records contain much more information about how a blast has performed. The seismogram is actually a record of explosive energy that was not used in fragmenting rock. The invention involves determining how to extract information that would be useful in analyzing blast performance. Blast performance can be important to help determine excavation rate in construction, fragmentation in quarrying, and ore/coal recovery in mining. However, such analysis can be difficult and expensive. Seismographs, which are routinely deployed in blasting functions, contain much information. The present invention has developed novel methods for extracting such information.

Each explosive charge generates strain pulses from the detonation of the explosive as well as the expansion of the gas that displaces the fragments. Part of that strain energy is used in fragmenting the rock; part of the strain energy propagates away from the blast site where the energy can be recorded as a set of wiggly lines. Untangling the meaning of those wiggly lines is not a simple task.

The detonation of explosives generates a strain pulse, which in turn fractures the rock. The strain pulse decays with distance until there is eventually no more rock fracture and the strain pulse becomes a vibration. The explosion further generates a blast vibration, which reflects the blast energy that was not used to fracture the rock. Analysis of the explosion allows one to see “leftover” remnants of the strain pulse and more vibration if there is more confinement of the explosives, as well as the vibration path effect.

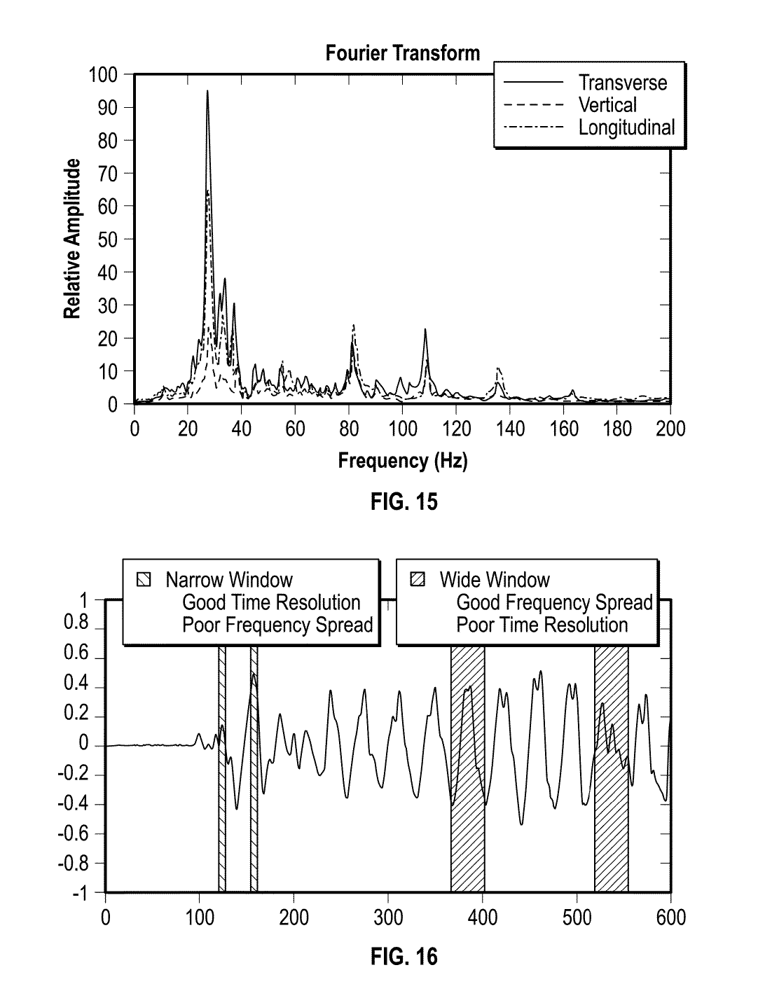

Simply scanning the record for high peaks can give a very rough idea of where in a shot there may have been excess confinement or other problems, but this does not qualify as a quantitative analytical method. The now-standard technique of Fourier transform frequency analysis, as shown in FIG. 15 can indicate which frequencies are present in the whole seismogram, but does not give any information as to when in the shot certain frequencies are dominant because time information is not present.

An analytical method called the wavelet transform provides a much more thorough analysis. These transforms localize frequency content in time. High frequencies are associated with the impulse from detonation. Lower frequencies may be related to the influence of local geology, or perhaps to later pulses from explosive expansion or movement of material.

Additionally, features in the FIGS. generated may be associated with accurate firing times, indications of misfire, and/or high confinement. This information can be determined from the seismogram, without any in-hole monitoring, leading to a quick and reliable analysis of blast performance.

First, the basis of wavelet transform analysis will be described, followed by examples of the application of continuous wavelet transforms (CWT) to actual blast waveforms. It is believed that this technique may truly transform the use of seismograms in analysis of blast performance.

While analyzing the waveform from a blast record and obtaining the peak levels and dominant frequency data are sufficient for compliance with regulations, there is much more information that can be mined from those seemingly inscrutable wiggly lines. One purpose of analyzing blast vibration waveforms is to determine how effectively the explosive energy was used in fragmenting rock.

Before a blast is detonated, it is known how many holes should have been loaded and how much explosive was to be loaded into each hole. We also know The intended sequence of detonations is also known, which should progress from the least confined area (either a free face or a burn cut) to the perimeter.

What is not necessarily known, however, is if all of the holes were loaded as proposed or if all of the holes fired; if the holes fired in the designed sequence or misfired due to either detonator malfunction or incorrect wiring; if the explosive performed properly; or if the overall design had induced regions of over- or under-confinement, causing problems in fragmentation, muck movement, or overbreak.

Some answers can be found through high-speed video of the face or borehole monitoring of, for example, the velocity of detonation. These techniques are useful, but require additional labor and time for implementation and analysis. Seismograms can also reveal answers, through the method of the present invention of deciphering using wavelet transform analysis.

Blasting is a very effective way to fracture and fragment rock for mining, quarrying and civil construction. Assessing that effectiveness can often be difficult and expensive because about all that is left after a blast is a pile of broken rock and an excavated hole. The usual assessment techniques (measurement of firing times, detonation velocity, face movement, and muckpile spread and fragmentation) require instrumentation and effort designed specifically for such an assessment.

On the other hand, blast vibration is monitored routinely with seismographs to demonstrate compliance with regulations. All that the seismograms thus collected are used for, generally, is to document the peak amplitude. The complete waveform, though, contains a wealth of untapped information. The method of the present invention described herein is designed to extract that information from blast seismograms.

To understand what information is recorded on the seismogram, it is important to understand what happens during a blast. Explosives fragment rock through their rapid conversion from a solid explosive into a much larger volume of gas. The expanding gas fragments rock by two distinct processes, namely, rapid application of a high-energy strain pulse to the borehole wall and subsequent pressurization of the borehole.

The strain pulse fractures the surrounding rock by interacting with existing discontinuities and by radial cracking around the borehole. The pressurization then extends the newly created fractures and displaces the fragments.

As the strain pulse propagates away from the borehole, the strain pulse loses energy as the strain pulse fractures rock, but also loses energy due to geometric spreading and inelastic damping. At a sufficient distance, typically on the order of ten borehole diameters, the energy in the strain pulse has decayed to a level below that necessary to create further fractures. This “wasted energy” is then what propagates away from the blast site as “vibration.”

Analysis of vibration waveforms focuses on characteristics that are related to this “wasted energy.” The conversion of explosive energy to vibration may be different for each explosive charge, so the analysis must be localized in time.

A familiar signal processing method is the Fourier transform, which determines the frequency content of a wave. See FIG. 15, which is an example of a blast measurement using a Fourier transform. The Fourier theorem proves that any continuous waveform, no matter how complicated, can be decomposed into sine and cosine waves (basis functions) with different amplitudes and phase shifts. This technique is very useful for analyzing “stationary” waves—ones that do not change during the analysis period. Examples would be a chord played on an organ or a train whistle. When analyzing “non-stationary” waves, however, such as an impulse or blast vibration wave, Fourier analysis does not provide any information about when a particular frequency is present.

One way of overcoming this problem is to use the Short Term Fourier Transform (STFT). In this method, as shown in FIG. 16, a time window is moved along the data and a series of Fourier transforms is calculated for each time window. A short window, which gives more accurate time information, limits the frequency resolution, however, and a long window limits the time resolution. This tradeoff limits the usefulness of the STFT method.

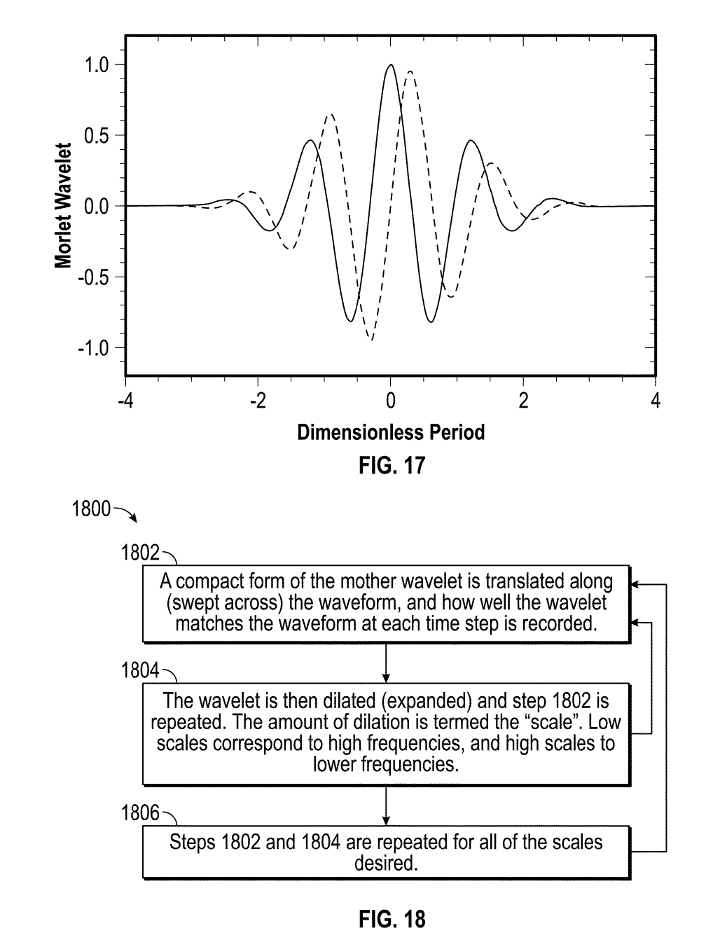

An alternative to the STFT is used in the present invention. Wavelet analysis is similar to Fourier analysis in that wavelet analysis decomposes a signal into constituent parts for analysis. However, instead of breaking the signal into a collection of sine and cosine waves of different frequencies, the wavelet transform breaks up the signal into wavelets, which are scaled and shifted versions of a “mother wavelet.” An example of a “mother wavelet” is shown in FIG. 17, in which the real part is shown by solid line and the imaginary part is shown by dashed line.

In comparison to the smooth and infinite sine and cosine waves used in Fourier analysis, the mother wavelet is compact, and may have sharp breaks, such as, for example, Daubechies wavelets. The shape allows wavelet transform to be used to analyze signals with discontinuities, while the compactness enables analysis localized in time.

There is an entire suite of wavelets, each with a different shape, that can be used for wavelet transform analysis. Exemplary wavelets are called Daubechies, symlets, Battle-Lemarie, Coiflets, Morlet, “Mexican hat”, etc. A Morlet wavelet is shown in FIG. 17. The “Mexican hat” has a shape like the cross section of a sombrero. Others can have more complicated shapes.

Each type of wavelet may be represented analytically by a variable-length series of coefficients. In the examples of analyses below, different wavelet types with different coefficient lengths have been tried, to determine which type of wavelet was most appropriate. Generally, one of the shorter and more simple wavelets (the Morlet wavelet shown earlier) seems to give the best results for blast waveforms.

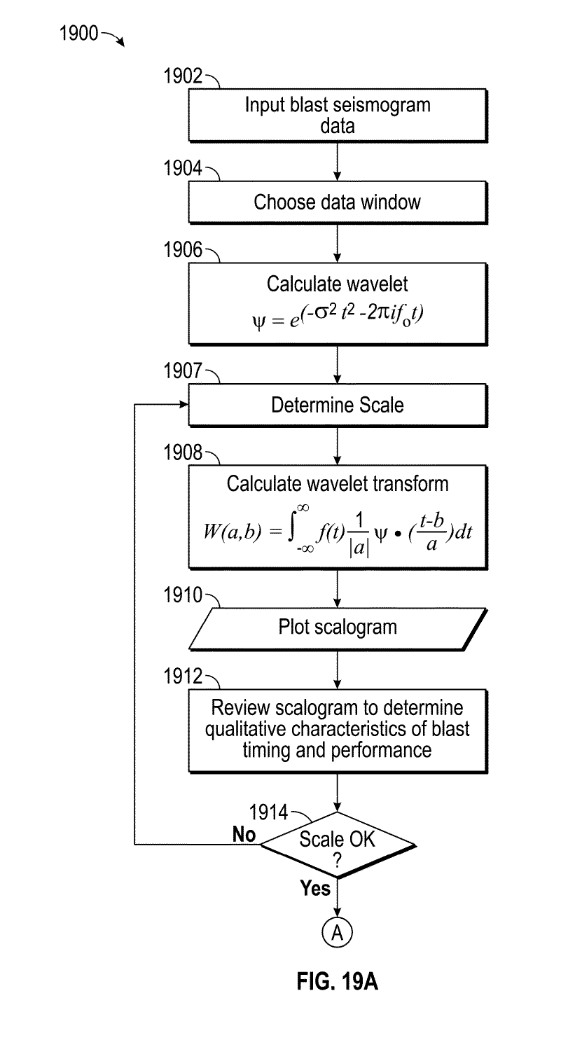

The mother wavelet may be used to generate a wavelet transform. An exemplary procedure to form a wavelet transform from a mother wavelet includes the following steps and as shown in flowchart 1800, shown in FIG. 18. In step 1802, a compact form of the mother wavelet is translated along (swept across) the waveform, and how well the wavelet matches the waveform at each time step is recorded. In step 1804, the wavelet is then dilated (expanded) and step 1802 is repeated as desired. The amount of dilation is termed the “scale”. Low scales correspond to high frequencies, and high scales to lower frequencies. In step 1806, steps 1802 and 1804 are repeated for all of the scales desired. For the purpose of providing a complete written description, mathematical details are provided below under the heading Mathematical Foundation of Wavelet Transform.

There are two general types of wavelet transform: the discrete wavelet transform (DWT) and the continuous wavelet transform (CWT). The type of wavelet transform is determined by how the scale steps are chosen. In DWT analysis, the scaling is based on a power of 2, also called “dyadic blocks”. There is no overlap between each calculation, so the calculation for each scale is independent of the others. In CWT, the scaling process is done in smaller steps that overlap, providing some redundancy. Each method has its advantages.

The results of a DWT may be displayed with a technique called multiresolution analysis (MRA), which plots waves that correspond to the match of the scaled mother wavelet for that scale. An advantage of the DWT is that DWT can be inverted (inverse discrete wavelet transform or IDWT), meaning that the waves generated by the DWT analysis can be summed to recover the initial waveform. In this way, certain frequency bands can be eliminated and the resultant waveform recovered. This technique is very useful for reducing the noise in a signal, by eliminating the noisy levels and recombining the remaining ones. A disadvantage of DWT analysis is that this dyadic (and discontinuous) scaling does not show how the various scales are related.

The CWT uses a slightly different approach. The CWT is more akin to an STFT in that the amplitudes, rather than the decomposed waves, are plotted as a function of time and scale. The result is what is plotted in 3D and projected onto a 2D representation called a scalogram.

Since there is not any way to determine beforehand what scales would be appropriate for the DWT/MRA analysis, the focus is on scalograms generated using CWT. Examples of scalograms are provided below.

In accordance with the present invention, the analysis of blast signals, seismograms and other impulses is performed using a general purpose digital computer programmed to carry out the method and may use commercially available software such as using MATLAB with the appropriate Toolboxes.

### Wavelet Transform Analysis of Blast Seismograms

### Example I

Example I shows how wavelet transforms can extract useful information from a blast seismogram. Referring now to FIGS. 10A-14C, the first example will demonstrate the basic approach on a fairly simple seismogram recorded about 370 feet from a fifteen hole electronic detonator quarry blast. The three components of the blast (transverse, vertical and longitudinal) are shown in FIGS. 10A-10C (vertical axis=particle velocity in inches/second; horizontal axis=time in milliseconds):

From the waveforms, the contribution of individual explosive charges cannot be assessed. Though one might try to pick out peaks, one would be hard pressed to say if all holes fired as designed with the inter-hole delay of 38 milliseconds and equal explosive charge weight.

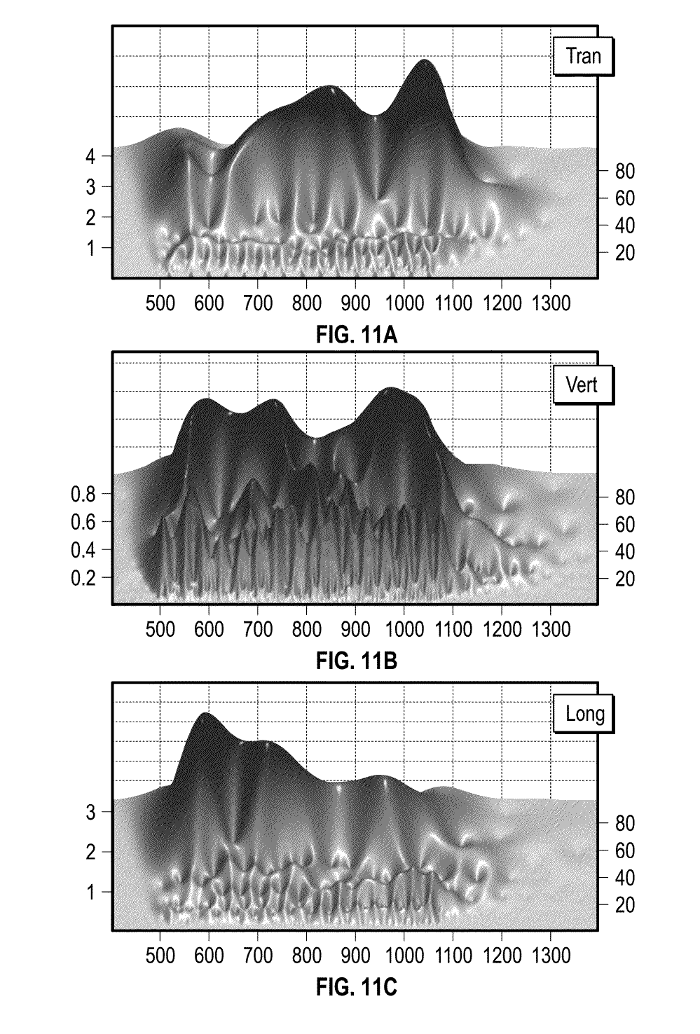

The waveforms and a CWT wavelet transform scalogram for each of the components are shown in FIGS. 11A-11C. The scalograms, as mentioned earlier, are projections of 3D plots, analogous to a relief map. The horizontal axis of the CWTs is time in milliseconds. The axis on the right shows the other horizontal axis which is “scale” (1/frequency). The axis on the left shows the amplitude in arbitrary units, which corresponds to the vertical dimension.

The low-frequency energy (in the background) dominates the graphs. This energy, due primarily to the influence of the geological path, is not what is to be focused on in the present analysis. The high-frequency energy in the foreground shows the contribution of individual boreholes. This can be seen more clearly by looking at the transverse component (FIG. 11A).

Pulses from each of the fifteen holes can be seen, as marked by the arrows. There is a slight variation in the heights of these pulses, though this blast in general performed quite well. As discussed above, the higher amplitude relates to less-efficient use of the explosive energy, so this may indicate some variation in explosive efficiency. In any case, evidence of the timing and energy of individual hole firings can now be extracted from a complicated waveform.

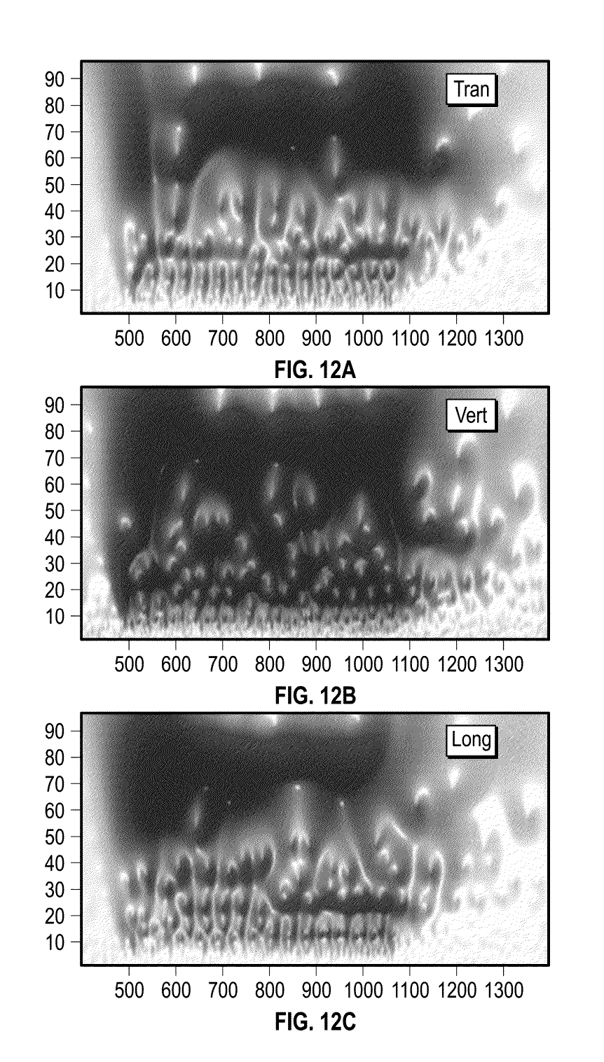

Alternatively, the 3D plots can be viewed from “above”, much like a map view (again with the artificial lighting and color-coding of amplitude), as shown in FIGS. 12A-C (scale is now on the left):

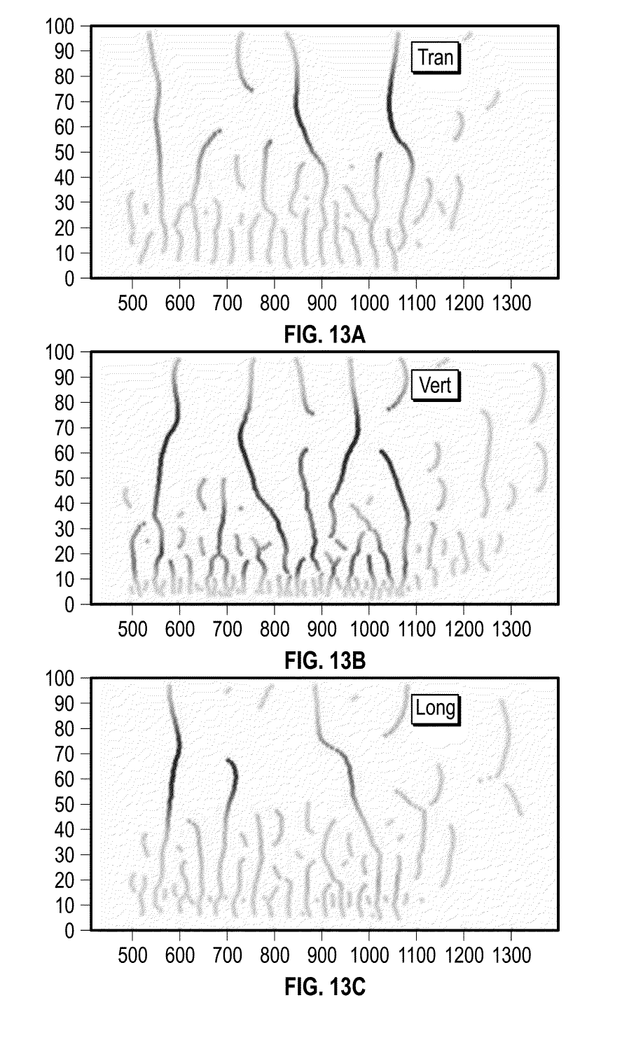

FIGS. 12A-C disclose the low-scale (i.e., high frequency) ridges associated with individual hole firings are evident. Plotting only the highest points of the ridges, using the same color codes as in the scalogram generates a Wavelet Transform Maximum Modulus (WTMM), shown in FIGS. 13A-C.

The WTMM simplifies the scalogram, displaying condensed information about amplitude and time. How the shape of the ridges varies with scale, at a given time, may also yield information about the blast efficiency. The ridge slope is related to a parameter called the Hölder or Lipschitz exponent, which has been shown to be related to abruptness of change in a signal. This has, in turn, been shown to be an indicator of potential damage in studies of Structural Health Monitoring.

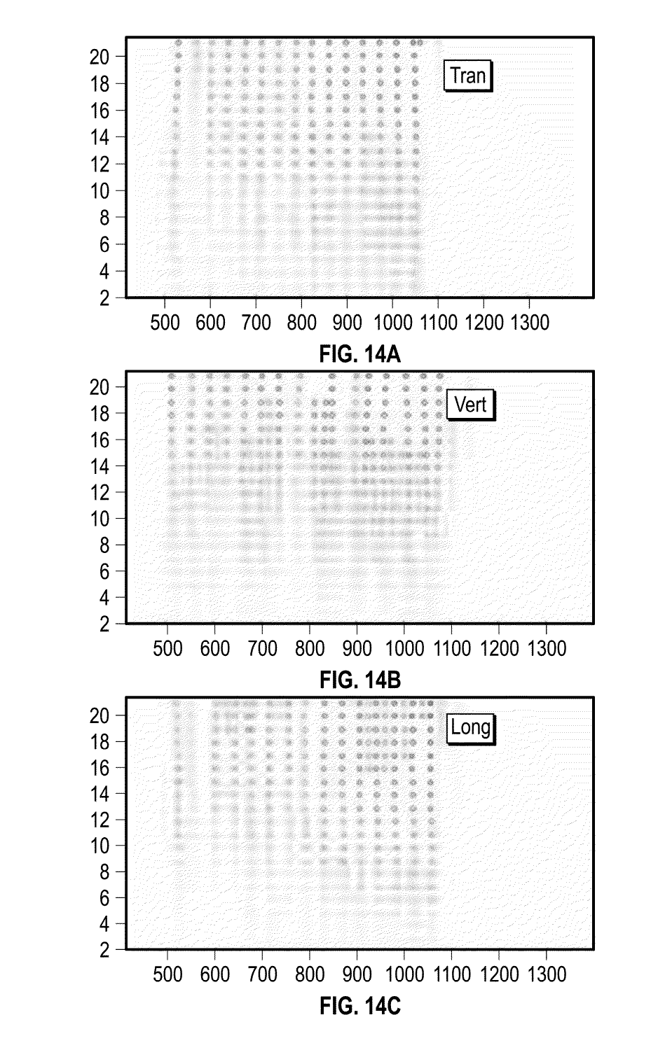

Zooming in to the low-scale portion of the WTMM cuts out the effect of the geological path and focuses on the pulses generated by the explosive detonation, as is shown in FIGS. 14A-C.

### Implications for Rock Mechanics

Instead of merely obtaining the peak amplitude of a waveform (i.e., peak particle velocity, or PPV), or a time-independent frequency spectrum, the wavelet transform evaluates explosive energy that was not used in fragmenting and displacing rock. This information provides a means of estimating the transmitted energy that propagates throughout the surrounding rock mass for each detonated borehole. In turn, the results can generate a better understanding of the potential for damage to the surrounding rock mass—a fundamental factor in determining the stability of underground and surface workings.

An accurate assessment of rock damage is essential to the “Hoek-Brown failure criterion,” an industry-standard failure criterion used for assessing stability of underground workings and surface mining structures. The 2002 edition of this criterion incorporates a “blast damage” or “disturbance” factor, D, that is determined subjectively. According to Hoek, “the influence of this disturbance factor can be large.” Therefore, a quantitative determination of this factor could have a substantial impact on assessments of stability, and therefore on the effort that must be given to support for underground facilities or to slope design for surface mining.

Several models have been developed that use PPV as an estimator of blast damage (Bauer-Calder, Holmberg-Persson, Mojitabai-Beattie, Lu-Hustrulid, and others) when attempting to reduce dilution and potential instability in mining. PPV comprises only one value for a given blast, however, while wavelet transform analysis evaluates the time dependence of the propagating wave and separates the direct detonation pulse information from other factors that influence the final shape of the waves.

Numerical analysis to be applied to rock mechanics problems would likely come from Wavelet Transform Modulus Maximum calculations or the Lipschitz/Hölder exponents derived from the WTMM. Both of these approaches have been shown to be related to structural stability and damage detection.

A more accurate estimate of failure criteria would improve mining and construction safety and reduce the costs for unnecessary support.

Wavelet transform analysis of conventional blast seismograms displays details of the blasting process that cannot be detected from a visual examination of the waveforms. Such analysis reveals low-scale (i.e., high-frequency) pulses that appear to be directly related to the detonation process. The effects of the geological path are then confined to higher scale (low-frequency) pulses, conveniently separating the two major influences on the vibration. The higher scale features may also be related to other events in the fracture process.

The details revealed through wavelet transform analysis and some potential applications include the following:
1. Wavelet transform analysis provides detailed information about the time-frequency behavior of a blast. This information may be useful in assessing effectiveness of vibration control methods.
2. Wavelet transform analysis extracts information about pulses related to the detonation of individual explosive charges. This information could be used to assess explosive efficiency on a routine basis.
3. Wavelet transform Modulus Maxima (WTMM) can be used to determine accurate firing times from complicated waveforms. This information is still important for analyzing conventional pyrotechnic initiation.
4. WTMM and associated Hölder and/or Lipschitz exponents may provide amplitude values for individual borehole detonations. Absolute amplitudes would be useful in determining choice of explosive types and/or delay sequences.
5. The application of these calculations to Hoek-Brown (or other) failure criteria may enhance rock mechanics calculations for assessing underground and surface stability. Damage associated with blasting has been qualitatively assessed thus far, and quantitative analysis should improve rock strength characterization, resulting in more accurate determination of appropriate mitigation measures.

6. Wavelet transform analysis may replace the use of PPV as a method for assessing rock damage due to blasting.

### Mathematical Foundation of Wavelet Transform Analysis

The underlying principle of the Wavelet Transform is that a signal (wave) can be decomposed into constituents in much the same manner as Fourier analysis decomposes a signal based upon sine and cosine waves of different frequencies and phases. In Fourier analysis, the sines and cosines comprise a set of basis functions.

For wavelet transforms, the basis functions are wavelets, which are a compressed and finite-length wave that is dilated (expanded) and translated in the analysis process. The initial form of the wavelet is often termed the “mother wavelet.”

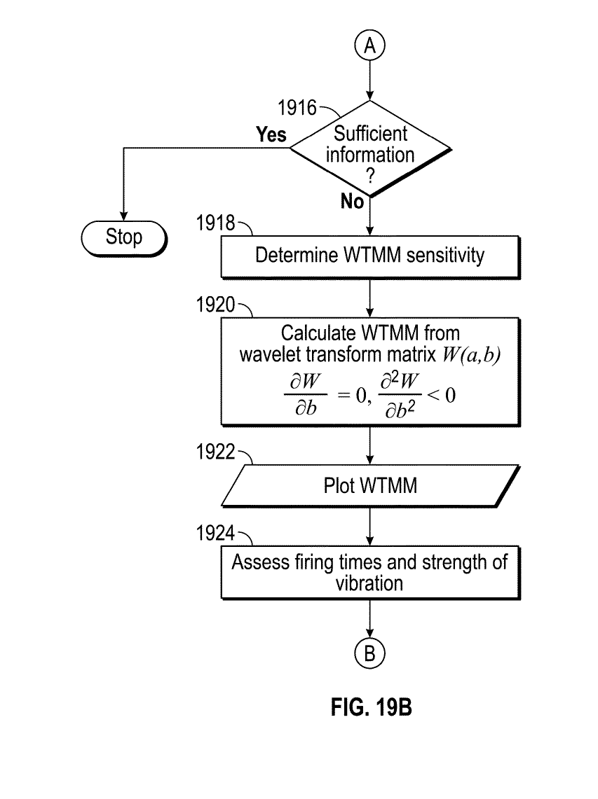

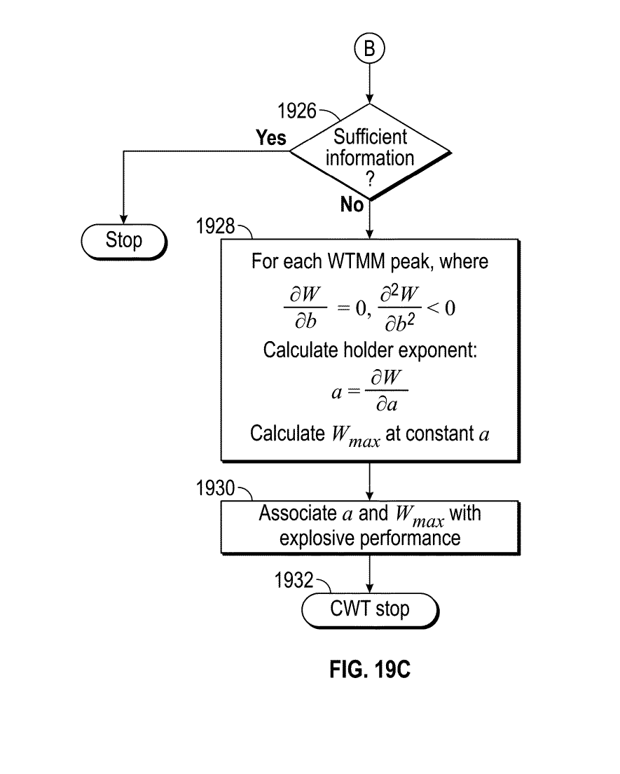

Referring now to FIGS. 19A-C there is shown a flow chart 1900 for the practice of an exemplary embodiment of the present invention.

The steps in an analysis of a blast (or signal) using Continuous Wavelet Transform (CWT) and associated processes are as follows. The numbered steps are shown in sequence in the block diagram.

Referring now to FIG. 19A, in step 1902, collect the signal, such as the vibration produced by a blast recorded on a seismograph, and input said data to the recording medium of a computer. Read the collected signal into the computer program. In step 1902, since much of the collected data is not part of the blast event, determine a start, end, and time step for the data. In step 1904, calculate the coefficients for a wavelet that is appropriate for a CWT. The block diagram shows that for a complex Morlet wavelet. Others, such as “Mexican Hat” are also appropriate.

In step 1907, determine the initial “Scale” to use in the analysis, again choosing a start, and end, and a scale interval. This will be reviewed following a calculation to determine the appropriateness. In step 1908, calculate the CWT coefficients, W, as a function of time (“b”) and scale (“a”) for the entire event. In step 1910, plot the modulus (|W|, the absolute value of the coefficients, in time-scale space on a 3D scalogram.

In step 1912, review the scalogram and determine both if the scale parameters (representing the frequency range) is appropriate, and qualitative characteristics of the signal. Low-scale peaks indicate impulsive signal characteristics related to detonations, and should be present. In step 1914, if the scale parameters are appropriate, continue to FIG. 19B at Y. If not, revise and rerun step 1907.

Referring now to FIG. 19B, in step 1916, if the scalogram(s) contains sufficient information for the desired analysis, stop; otherwise, continue to step 1918. In step 1918, determine the appropriate sensitivity for calculating a Wavelet Transform Maximum Modulus (WTMM). This procedure determines the location of “ridges” or maxima in the scalogram. In step 1920, the computer calculates the WTMM on the basis of two criteria: That at a given “b”, the change in CWT modulus with respect to “b” is zero (i.e., flat); and that the slope on either side of this flat spot goes down (i.e., that it is a peak rather than a valley).

In step 1922, the computer plots these peaks (tops of the ridges), again in time-scale space. In step 1924, use the location of the ridges to assess the firing times of the detonations, through determining where these ridges occur along the time axis. Also, qualitatively determine the strength of the vibration from the amplitude of the ridges. Go on to FIG. 19C at Z.

Referring now to FIG. 19C, if, in step 1926, the WTMM contains sufficient information for the desired analysis, stop; otherwise, continue to step 1928. In step 1928, for each of the ridges (i.e., the WTMM peak lines at constant time), calculate two values: first, the slope of the ridge, which in log-log space of W vs. scale is called the Holder exponent; and second, the maximum value of W at low scale. The maximum value is associated with the maximum value of the impulse, and the Holder exponent is associated with the “impulsiveness” of the signal. In step 1930, use these two parameters to assess the explosive performance for each of the impulses. In step 1932, stop the analysis.

A similar process can be done to analyze detonation-induced vibration using Discrete Wavelet Transform (DWT).

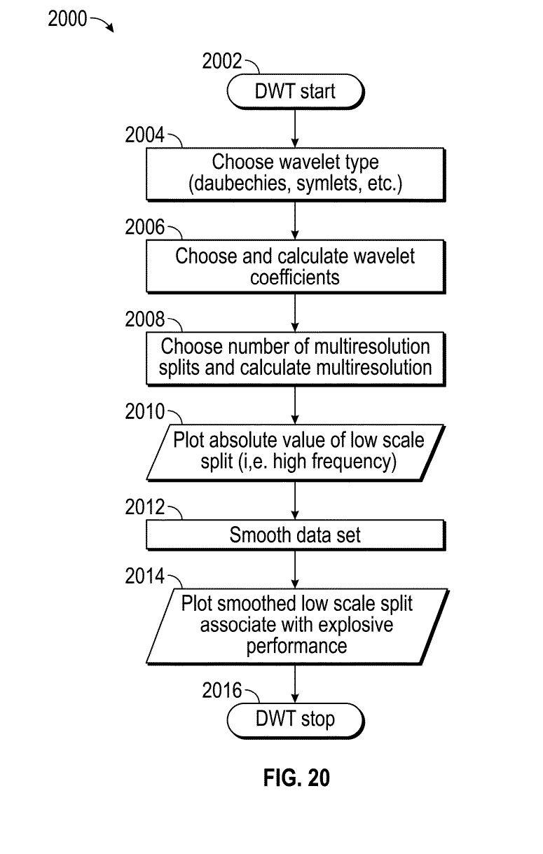

Referring now to FIG. 20, there is shown a flow chart 2000 of another exemplary embodiment of the present invention utilizing Discrete Wavelet Transforms (DWT). The steps in an analysis of a blast (or signal) using (DWT) and associated processes steps are as follows, as shown in sequence in the flow diagram 2000. In step 2002, the beginning of the DWT analysis assumes that the same information as at the beginning of the CWT process has been accomplished, namely:
a. Collect the signal, such as the vibration produced by a blast recorded on a seismograph, and input said data to the recording medium of a computer. Read the collected signal into the computer program.
b. Since much of the collected data is not part of the blast event, determine a start, end, and time step for the data.

In step 2004, choose a type of wavelet that is appropriate for a DWT. There are many well-known types (e.g., Daubechies, Symlets, Coiflet, Haar, etc.). Analysis may be done with various types, based upon signal characteristics. In step 2006, determine the number of coefficients for the chosen wavelet type, and calculate them. This procedure is different from the CWT in that the number of coefficients is also variable and affects the analysis.

In step 2008, the DWT running on the computer decomposes the signal into several signals (or “splits”) that are determined by discrete scales in a process called multiresolution. The desired number of splits must be chosen, and then the multiresolution calculation performed on the original signal. In step 2010, as with the CWT, the low scale split is related to high frequency, and thus to the impulse characteristics of the signal. The lowest scale split is plotted to determine if wavelet type, number of coefficients, and number of splits is appropriate. The absolute value is plotted to simplify visual analysis. In step 2012, if deemed appropriate, the data set consisting of individual wavelet peaks can be then smoothed with an appropriate filter (such as Savitsky-Golay) to accurately define the contribution of individual impulses.

In step 2014, the smoothed data set is then plotted by the computer and reviewed to assess impulsiveness (by the breadth of the peaks) and amplitude (maximum height of the peaks) and use these to assess detonation effectiveness and fragmentation. In step 2016, if this is sufficient information, the process can be stopped; otherwise, steps 2002-2016 can be repeated with a different wavelet type, different coefficients, different smoothing filters, for different multiresolution variables.

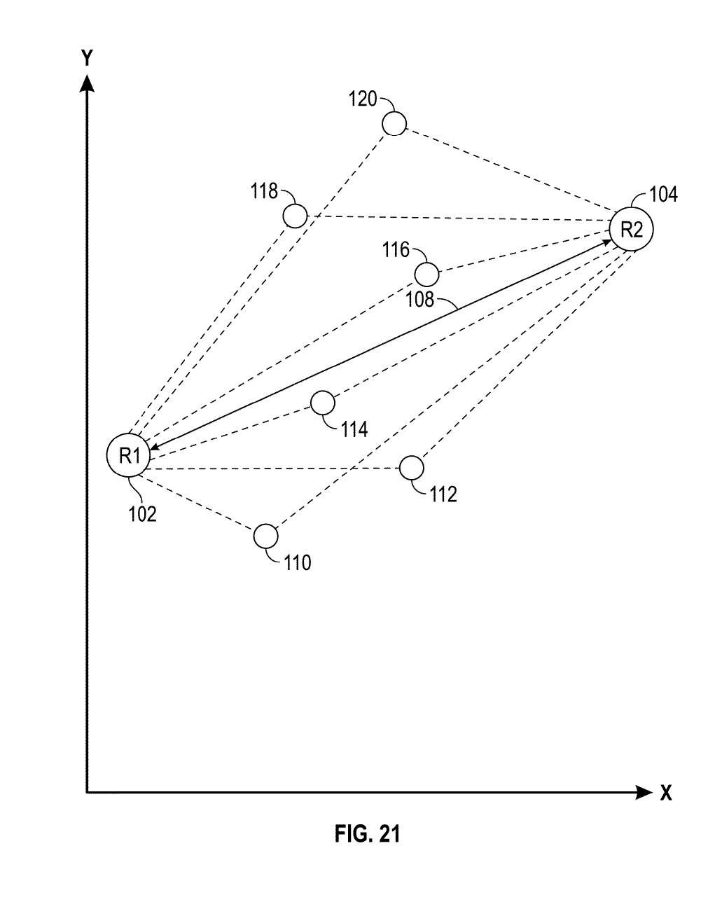

Multiple recording devices can be used to simultaneously record an event. The spacing of the recording devices apart from each other can be used to determine relative locations of blast impulses, as well as to determine the strength of blasts and the efficiency of fragmentation of rocks as a result of the multiple blasts. By way of example, referring to FIG. 21, a first recording device 102 is located at a first position and a second recording device 104 is located at a second position. First recording device 102 and second recording device 104 are separated from each other by a distance 106 and along a vector 108. Blast locations 110-120 are located at various locations as shown in the figure. By using triangulation, as shown by the dashed lines in the figure, the location of each blast can be identified.

If recorders 102, 104 are located on opposing sides of a blast site, such as is shown in FIG. 21, the recorded data can provide an indication of how effectively the explosives detonate, as well as the efficiency of fragmentation of the blast.

While a recorder used in measuring data from blasts has been described herein as a seismograph, those skilled in the art will recognize that other types of recorders can be used to record an event that includes a plurality of blasts or other energy generators, such as, for example, gunshots. An audio recorder, such as, for example, even a cell phone, can be used to record and play back audio signals of an event and to analyze the event using wavelets, as described above.

In an alternative embodiment, the present invention can be used to analyze an audio recording of multiple sounds, such as, for example, gunshots. If an audio recording device captures audio of a gun shootout, the present invention can be used to resolve the recorded sounds and, by eliminating background noise, echoes, and ricochets, determine the number of shots fired and possibly distinguish different guns (i.e., 9 millimeter, .38 caliber, .22 caliber, etc.) being fired. Similar to the example above using recorders 102, 104, other recorders, such as cell phones, can be spaced at different locations relative to the shooters, and the present invention can be used to help determine at least approximate locations of each of the shooters, the number of shots fired form each approximate location, and what type of gun was fired from each location.

Reference herein to “one embodiment” or “an embodiment” means that a particular feature, structure, or characteristic described in connection with the embodiment can be included in at least one embodiment of the invention. The appearances of the phrase “in one embodiment” in various places in the specification are not necessarily all referring to the same embodiment, nor are separate or alternative embodiments necessarily mutually exclusive of other embodiments. The same applies to the term “implementation.”

As used in this application, the word “exemplary” is used herein to mean serving as an example, instance, or illustration. Any aspect or design described herein as “exemplary” is not necessarily to be construed as preferred or advantageous over other aspects or designs. Rather, use of the word exemplary is intended to present concepts in a concrete fashion.

Additionally, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Moreover, the terms “system,” “component,” “module,” “interface,”, “model” or the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

Although the subject matter described herein may be described in the context of illustrative implementations to process one or more computing application features/operations for a computing application having user-interactive components the subject matter is not limited to these particular embodiments. Rather, the techniques described herein can be applied to any suitable type of user-interactive component execution management methods, systems, platforms, and/or apparatus.

The present invention may be implemented as circuit-based processes, including possible implementation as a single integrated circuit (such as an ASIC or an FPGA), a multi-chip module, a single card, or a multi-card circuit pack. As would be apparent to one skilled in the art, various functions of circuit elements may also be implemented as processing blocks in a software program. Such software may be employed in, for example, a digital signal processor, micro-controller, or general-purpose computer.

The present invention can be embodied in the form of methods and apparatuses for practicing those methods. The present invention can also be embodied in the form of program code embodied in tangible media, such as magnetic recording media, optical recording media, solid state memory, floppy diskettes, CD-ROMs, hard drives, or any other machine-readable storage medium, wherein, when the program code is loaded into and executed by a machine, such as a computer, the machine becomes an apparatus for practicing the invention. The present invention can also be embodied in the form of program code, for example, whether stored in a storage medium, loaded into and/or executed by a machine, or transmitted over some transmission medium or carrier, such as over electrical wiring or cabling, through fiber optics, or via electromagnetic radiation, wherein, when the program code is loaded into and executed by a machine, such as a computer, the machine becomes an apparatus for practicing the invention. When implemented on a general-purpose processor, the program code segments combine with the processor to provide a unique device that operates analogously to specific logic circuits. The present invention can also be embodied in the form of a bitstream or other sequence of signal values electrically or optically transmitted through a medium, stored magnetic-field variations in a magnetic recording medium, etc., generated using a method and/or an apparatus of the present invention.

Unless explicitly stated otherwise, each numerical value and range should be interpreted as being approximate as if the word “about” or “approximately” preceded the value of the value or range.

The use of figure numbers and/or figure reference labels in the claims is intended to identify one or more possible embodiments of the claimed subject matter in order to facilitate the interpretation of the claims. Such use is not to be construed as necessarily limiting the scope of those claims to the embodiments shown in the corresponding FIGS.

It should be understood that the steps of the exemplary methods set forth herein are not necessarily required to be performed in the order described, and the order of the steps of such methods should be understood to be merely exemplary. Likewise, additional steps may be included in such methods, and certain steps may be omitted or combined, in methods consistent with various embodiments of the present invention.

Although the elements in the following method claims, if any, are recited in a particular sequence with corresponding labeling, unless the claim recitations otherwise imply a particular sequence for implementing some or all of those elements, those elements are not necessarily intended to be limited to being implemented in that particular sequence.

As used herein in reference to an element and a standard, the term “compatible” means that the element communicates with other elements in a manner wholly or partially specified by the standard, and would be recognized by other elements as sufficiently capable of communicating with the other elements in the manner specified by the standard. The compatible element does not need to operate internally in a manner specified by the standard.

Also for purposes of this description, the terms “couple,” “coupling,” “coupled,” “connect,” “connecting,” or “connected” refer to any manner known in the art or later developed in which energy is allowed to be transferred between two or more elements, and the interposition of one or more additional elements is contemplated, although not required. Conversely, the terms “directly coupled,” “directly connected,” etc., imply the absence of such additional elements.

The invention is not limited to the examples described and may be used for extracting commercially useful information by use of a computer from any overall signal, waveform or impulse of any type generated by a plurality of signals, waveforms or impulses by use of a computer using the methods and analysis described herein to provide information on the timing, strength and other characteristics of each of the original plurality making up the overall impulse waveform or signal.

1. A method, comprising extracting data from a signal, the signal being generated by a plurality of impulses, by use of a computer using wavelet transform analysis of the signal to determine timing and characteristics of each of said plurality of impulses.

2. The method according to claim 1, wherein the wavelet transform analysis comprises a discrete wavelet transform analysis.

3. The method according to claim 1, wherein the wavelet transform analysis comprises a continuous wavelet transform analysis.

4. A method of analyzing a blast event using Continuous Wavelet Transform (CWT) comprising:
(a) collecting a signal produced by a blast recorded and on a seismograph;
(b) inputting the data to the recording medium of a computer;
(c) reading the collected signal into a computer program on the computer;
(d) determining a start, end, and time step for the data;
(e) choosing a wavelet type;
(f) calculating coefficients;
(g) determining the initial scale to use in the analysis and choosing a start, and end, and a scale interval;
(h) calculating CWT coefficients as a function of time and scale for the entire blast event;
(i) plotting a modulus of the absolute value of the coefficients in time-scale space on a 3D scalogram;
(j) determining both if the scale parameters, the scale parameters representing the frequency range, is appropriate, and qualitative characteristics of the signal, such that low-scale peaks indicate impulsive signal characteristics related to detonations;
(k) continuing to step (l) if the scale parameters are appropriate, and, if not, revising and rerunning the CWT at step (g); and
(l) stopping the analysis if the scalogram(s) contains sufficient information for the desired analysis.

5. The method according to claim 4, further comprising if, in step (l), the scalogram(s) do not contain sufficient information for the desired analysis, determining the appropriate sensitivity for calculating a Wavelet Transform Maximum Modulus.

6. The method according to claim 5, wherein the Wavelet Transform Maximum Modulus is calculated on the basis of two criteria:
(a) that at a given “b”, a change in the Continuous Wavelet Transform modulus with respect to “b” is zero and is therefore a flat spot; and
(b) that the slope on either side of the flat spot goes downward, defining the flat spot as a relative peak.

7. The method according to claim 6, wherein each peak is plotted in time-scale space.

8. The method according to claim 7, wherein a locus of flat spots forms a ridge, the method further comprising use a location of the ridges to assess firing times of the detonations, through determining the location of the ridges occur along a time axis.

9. The method according to claim 8, further comprising qualitatively determining a strength of the vibration from the amplitude of the ridges.

10. The method according to claim 9, wherein, if the Wavelet Transform Maximum Modulus contains sufficient information for the desired analysis, stop the analysis and, if the Wavelet Transform Maximum Modulus does not contain sufficient information, calculate a Holder Exponent, and a Wₘₐₓ at a constant a and associate the Holder exponent and the Wₘₐₓ with explosive performance.

11. The method according to claim 9, wherein for each of the ridges, the method further comprises:
calculating a slope of the ridge, the slope in log-log space of W vs. scale being called the Holder exponent; and
calculating a maximum value of W at low scale.

12. The method according to claim 11, further comprising, using the slope of the ridge and the maximum value of W to assess the explosive performance for each of the impulses.

13. The method according to claim 4, wherein the signal comprises a vibration signal.

14. A method for extracting data from a signal, the signal being generated by a plurality of impulses, the method comprising:
(a) collecting signal data, the signal data including vibration produced by the blast recorded on a seismograph;
(b) inputting the signal data to a recording medium of a computer;
(c) reading the collected signal from the recording medium into a computer program on the computer;
(d) determining a start time, an end time, and a time step for the data;
(e) choosing an appropriate type of wavelet;
(f) determining a number of coefficients for the chosen wavelet type; and
(g) selecting one of a Continuous Wavelet Transform analysis and a Discrete Wavelet Transform analysis to analyze the data.

15. The method according to claim 14, further comprising if, in step (g), the Discrete Wavelet Transform analysis is selected, performing the following steps:
(h) calculating the coefficients for the chosen wavelet type;
(i) decomposing the signal data into a plurality of splits that are determined by discrete scales in a process called multiresolution, wherein the desired number of splits is chosen, and then the multiresolution calculation performed on the original signal;
(j) plotting the lowest scale split is plotted to determine if the wavelet type, number of coefficients, and number of splits is appropriate, and, if so, smoothing a data set consisting of individual wavelet peaks with an appropriate filter to define the contribution of individual impulses; and
(k) plotting the smoothed data set by the computer and reviewing the plotted smoothed data set to assess impulsiveness and amplitude and use the impulsiveness and amplitude to assess detonation effectiveness and fragmentation.

16. The method according to claim 15, further comprising selecting a different wavelet and repeating steps (h)-(k).

17. The method according to claim 15, further comprising determining a different number of coefficients and repeating steps (h)-(k).

18. The method according to claim 15, further comprising selecting different multiresolution variables and repeating steps (j)-(k).

19. The method according to claim 15, further comprising, altering the smoothing of the data set and repeating step (k).

20. The method according to claim 14, further comprising if, in step (g), the Continuous Wavelet Transform analysis is selected, performing the following steps:
(h) determining the initial scale to use in the analysis and choosing a start, and end, and a scale interval;
(i) calculating CWT coefficients as a function of time and scale for the entire blast event;
(j) plotting a modulus of the absolute value of the coefficients in time-scale space on a 3D scalogram;
(k) determining both if the scale parameters, the scale parameters representing the frequency range, is appropriate, and qualitative characteristics of the signal, such that low-scale peaks indicate impulsive signal characteristics related to detonations;
(l) continuing to step (l) if the scale parameters are appropriate, and, if not, revising and rerunning the CWT at step (g); and
(m) stopping the analysis if the scalogram(s) contains sufficient information for the desired analysis.
